(19) United States
(12) Patent Application Publication
(10) Pub. No.: US 2024/0185335 A1
(43) Pub. Date: Jun. 6, 2024

(54) COMPUTER SYSTEM, METHOD, AND DEVICE FOR A FINANCIAL SERVICES AGGREGATION SYSTEM

(71) Applicant: 10353744 Canada Ltd., Kitchener (CA)

(72) Inventor: Mark Church, Waterloo (CA)

(21) Appl. No.: 18/529,067

(22) Filed: Dec. 5, 2023

Related U.S. Application Data
(60) Provisional application No. 63/430,340, filed on Dec. 5, 2022.

(51) Int. Cl. G06Q 40/02; G06Q 30/0251; H04L 9/40

(52) U.S. Cl. CPC G06Q 40/02; G06Q 30/0255; H04L 63/0815

(57) ABSTRACT

Provided is a financial services aggregation system comprising: a financial vault for supporting financial services between a client terminal and a plurality of financial institution systems, configured to: deliver a request of accessing a user's financial account to a user aggregation identity system for identity verification and authentication when a user is logging into a user's account on the client terminal to access the user's financial account on the client terminal; receive a confirmation message from the user aggregation identity system when user's identity has been verified and the user's financial account has been authenticated by the user aggregation identity system; and deliver a query result of the personal banking data from the financial institutions' systems to the client terminal.

### TECHNICAL FIELD

The embodiments disclosed herein relate to a financial services aggregation system, processing method, and user device, and, in particular to systems, methods, and devices for financial services aggregation.

### INTRODUCTION

Development of the Internet makes online banking convenient and efficient, and accordingly many people tend to perform personal financial services online. Online personal financial services include personal information updating, account balance checking, bank transfers, transaction history queries, and so on.

Generally, bank transfers occur on a user's online banking account from the user to another user. In the online banking account context, bank transfers can be generated by inputting a recipient's email address to initiate an email money transfer or inputting the recipient's bank account number and issuing bank name to initiate an online bank transfer.

In current personal financial trends, many people have at least one bank card issued by various issuing banks, especially credit cards; for example, a user may have one regular cash-back credit card for daily use, while an additional credit card is maintained for an emergency expense or for a large expense. Each issuing bank may have released their own website or mobile application. The user must log in at each bank's website or mobile application to complete online personal financial services, including personal information updating, account balance checking, bank transfers, transaction history queries, and so on.

With the development of E-commerce, online payment for purchasing goods is becoming more and more common, and the user must input credit card information at least once on an online shopping website for making payments. Such inputting is time-consuming and inconvenient. On the other hand, there is a potential risk in saving credit card information on the online shopping website in that the shopping website may be the victim of a cyberattack or its data hacked. Such a cyberattack or hack would jeopardize the user's financial security in revealing confidential financial information, such as the saved credit card information, to the perpetrators thereof or even to the general public at large.

In addition, personal banking data in the online banking system cannot be authorized by users for a third-party use.

Accordingly, there is a need for an improved system, method, and device that overcomes at least some of the disadvantages of existing systems and methods.

### SUMMARY

An object of the present invention is to provide a computer system for financial services aggregation, and associated method and device for enabling users to log into a single financial services aggregation system to access all user accounts and data across all financial institutions' systems (FI systems), while maintaining account security. Advantageously, such a user may not be required to log into each financial institution's system (FI system) to access each user account separately, which may accordingly improve efficiency and security of personal payment information.

The financial services aggregation system enables the user to process interbank financial services conveniently and effectively. Advantageously, the user may not need to switch accounts to which the user is logged in among various financial institution applications.

The various embodiments described herein generally relate to methods (and associated systems and devices configured to implement the methods) for the financial service aggregation system to perform online personal financial services conveniently and manageably.

A financial services aggregation system is provided, the financial services aggregation system including a financial vault for supporting financial services between a client terminal and a plurality of financial institution systems, configured to receive a query request for accessing a plurality of financial accounts of a user and deliver the request to a user aggregation identity system for identity verification and authentication when the user logs into a user account on the client terminal to access the plurality of financial accounts on the client terminal, each financial account associated with a respective financial institution system, receive a confirmation message from the user aggregation identity system when the identity of the user has been verified and the plurality of financial accounts have been authenticated by the user aggregation identity system, and deliver a query result from at least one of the plurality of financial institution systems to the client terminal. The client terminal is for accessing the plurality of financial accounts and configured to deliver the query request for accessing the plurality of financial accounts to the financial vault when the user logs into the user account, initiate the query request on the financial vault, to access personal banking data under the plurality of financial accounts on the respective financial institution systems, when the identity of the user has been verified and the plurality of financial accounts have been authenticated, receive the query result including at least some of the personal banking data from the at least one of the respective financial institution systems through the financial vault. The user aggregation identity system is configured to verify the identity of the user and authenticate the plurality of financial accounts according to the request, deliver the confirmation message for identity verification and authentication for the plurality of financial accounts to the financial vault when the identity of the user has been verified and the plurality of financial accounts have been authenticated, and provide a permission for accessing the plurality of financial accounts on the respective financial institution systems to the client terminal through the financial vault.

The financial vault may be further configured to analyze processing data on the client terminal by using machine-learning algorithms to provide summary financial data.

The processing data may include data on any past event related to financial services on the client terminal.

The financial vault may be further configured to predict future transactions by using machine-learning algorithms to provide recommended financial services to the client terminal.

The recommended financial services may be generated by the machine-learning algorithms based on predicting the future transactions.

The system may further include an e-commerce platform.

The e-commerce platform may be communicatively connected to the client terminal and the respective financial institution systems.

The e-commerce platform may be configured to generate and deliver a payment request of a seller terminal, according to an order placed by the client terminal, to one of the plurality of financial accounts synced on the financial vault for requesting a payment to the seller terminal, forward a frozen-funds confirmation message to the seller terminal, to enable the seller terminal to arrange delivery of an order when receiving the frozen-funds confirmation message delivered by the respective financial institution system corresponding to the one of the plurality of financial accounts through the financial vault, receive a delivery receipt received by the client terminal, to enable a frozen amount of funds to be unfrozen and transferred from the one of the plurality of financial accounts to a seller financial account, and deliver a funds receipt received by the financial fault, to update order status.

The financial vault may be further configured to receive the payment request of the seller terminal delivered by the e-commerce platform, according to an order placed by the client terminal, deliver the request for accessing the plurality of financial accounts to the user aggregation identity system when the user logs into one of the plurality of financial accounts on the client terminal, forward a request for funds of the order received by the client terminal to one of the respective financial institution systems, to enable the one of the respective financial institution systems to freeze the amount of funds in one of the plurality of financial accounts equivalent to an amount of funds of a payment order, deliver a transfer request to the one of the respective financial institution systems when receiving the delivery receipt sent by the client terminal, to enable the frozen amount of funds to be unfrozen and transferred from the one of the plurality of financial accounts to a financial account of a seller, according to the payment request of a terminal of the seller, forward a funds receipt delivered by a financial institution system of a seller to the e-commerce platform, to enable the e-commerce platform to update the order status.

The user aggregation identity system may be communicatively connected to the respective financial institution systems for identity verification and authentication via a network.

The respective financial accounts may be financial accounts under the name of the user and associated with corresponding identity information.

The plurality of financial accounts may be registered on the respective financial institution systems.

The plurality of financial accounts may include at least one functional account.

The functional account may include a checking account.

The functional account may include a savings account.

The functional account may include an investment account.

The functional account may include a loan account.

A computer implemented method for a financial services aggregation system is provided, the method including delivering a request for accessing a plurality of financial accounts of a user to a user aggregation identity system for identity verification and authentication when logging into a user account on a client terminal, each financial account associated with a respective financial institution system, receiving a confirmation message from the user aggregation identity system when the identity of the user has been verified and the plurality of financial accounts have been authenticated by the user aggregation identity system, initiating a query request at the client terminal on a financial vault to send the query request to the respective financial institution systems, to enable the financial vault to access personal banking data under the plurality of financial accounts on the financial institution systems, and delivering a query result including the personal banking data from at least one of the respective financial institution systems to the client terminal.

The method may further include receiving a payment request delivered by an e-commerce platform, according to an order placed by the client terminal, delivering a payment message of a seller terminal, according to the order placed by the client terminal, to a financial institution system of a seller for reference, and delivering a transfer request to the respective financial institution system when receiving a delivery receipt sent by the client terminal, to enable a frozen amount of funds to be unfrozen and transferred from one of the plurality of financial accounts to a financial account of a seller, according to the payment message.

A computer server in a financial services aggregation system is provided, the computer server including a data query module, configured to deliver a query request for accessing one of a plurality of financial accounts to a user aggregation identity system for identity verification and authentication when a user logs into a user account on a client terminal, each financial account associated with a respective financial institution system, retrieve specific information about available financial services provided by a specific financial institution system as requested by the client terminal, and deliver a query result including personal banking data from at least one of the respective financial institution systems to the client terminal. The computer server further includes a data parsing module, configured to receive a confirmation message from the user aggregation identity system when the identity of the user has been verified and the plurality of financial accounts have been authenticated by the user aggregation identity system and aggregate the personal banking data from the plurality of financial accounts on the respective financial institution systems when the query request is responded to by the respective financial institution systems. The computer server further includes a data analytics module configured to analyze processing data related to operational commands and logs on the client terminal through the financial vault by using machine-learning algorithms to provide summary financial data and predict future transactions by using the machine-learning algorithms to provide recommended financial services to the client terminal. The computer server further includes a database for storing the processing data.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic diagram of a financial services aggregation system 10, according to an embodiment;

FIG. 2 is a block diagram of a computing device for a financial services aggregation system 10 of FIG. 1, according to an embodiment;

FIG. 3 is a block diagram of a computer system for aggregating financial services, according to an embodiment;

FIG. 4 is a flow chart of a computer-implemented method for aggregating financial services, according to an embodiment;

FIG. 5 is a flow chart of a computer-implemented method of aggregating financial services in a financial vault, according to an embodiment;

FIG. 6 is a flow chart of a computer-implemented method for aggregating financial services in an e-commerce transaction, according to an embodiment; and

FIG. 7 is a block diagram of a computer server for a financial services aggregation system of FIG. 1, according to an embodiment.

### DETAILED DESCRIPTION

Various apparatuses or processes will be described below to provide an example of each claimed embodiment. No embodiment described below limits any claimed embodiment, and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistant, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage medium or a device readable by a general or special purpose programmable computer for configuring and operating the computer when the storage medium or device is read by the computer to perform the procedures described herein.

A description of an embodiment with several components in communication with each other does not imply that all such components are required. On the contrary, a variety of optional components is described to illustrate the wide variety of possible embodiments of the present disclosure.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The present disclosure provides a financial services aggregation system, method, and device for allowing the user to log into an aggregation system at one time to access all user accounts and data across all FI systems without a requirement to log in each FI system to access each user account separately.

The system, method, and device may further advantageously allow the user to select online personal financial services conveniently and manageably.

The financial services aggregation system may advantageously provide improved efficiency for online personal financial activities by using a financial vault for all data processing.

The financial services aggregation system may advantageously provide improved security for online personal financial activities by using a user aggregation identity system for identity verification and authentication.

The computer-implemented methods may advantageously access all accounts under the user's name in order to perform financial services efficiently and manageably.

The computer-implemented methods may be executed by using a client terminal, such as a smartphone or personal computer. In other embodiments, the client terminal may be any computer or device capable of performing functions similar to at least some of the functions of a computer.

Accordingly, the financial services aggregation system may allow the user to log into one system to access all accounts and data across the user's associated FI systems in order to perform online personal financial services conveniently and manageably without having to log into each FI system to access each user account separately.

Advantageously, the financial services aggregating system may include a financial vault for reducing a great number of requests made by a plurality of financial applications to various lines of backend services.

In addition, the user may be able to make online payments for online shopping via the financial services aggregation system without re-inputting personal payment information in order to improve the efficiency and security of online personal financial activities.

This systems and methods described herein have physical existence and/or manifest a discernible physical effect or change. This systems and methods described herein relate to the manual or productive arts, meaning those arts involving or concerned with applied and industrial sciences. The computer systems described herein have a material effect on the working of the invention and cooperate with other elements of the claimed invention.

Where the computer systems herein are programmed to run an algorithm, the computer processes the algorithm in a novel manner and the processing of the algorithm on the computer solves problems in the functioning of the computer. The computer and the algorithm form part of a single actual invention that solves a problem related to the manual or productive arts. Running the algorithms described herein on the computer improves the functioning of the computer, and the computer and the algorithm together form a single actual invention that solves a problem related to the manual or productive arts.

Moreover, the systems, methods, and devices described herein improve the computer and the functioning of the computer on which they are implemented. For example, a computer device (e.g., a server) implementing the systems, methods, and devices of the present disclosure may advantageously query and aggregate information more efficiently than conventional systems, methods, and devices, i.e., causing less processing on or by the computer device. Similarly, a computer device implementing the systems, methods, and devices of the present disclosure may advantageously make fewer requests for financial information, thus causing reduced transmission of sensitive information, thereby improving security of the sensitive information and of the computer device. Thus the functionality of such a computer device and the computer itself are thereby improved.

Furthermore, the systems, methods, and devices of the present invention solve a computer problem in that freezing funds in a designated buyer's financial account equivalent to an amount of funds of a payment order may further reduce computer processing and improve computer security in that funds need not be transferred until a condition is met or transaction confirmed, i.e., funds may be frozen but not transferred, thereby avoiding computer processing and exposure of sensitive information (e.g., if funds are transferred, the transaction cancelled or refunded, and the funds sent back).

Furthermore, the devices described herein, the systems including the devices, and the methods performed on, with, or to yield the devices, and the data run on, generated by, or provided or processed in connection with the foregoing correspond to more than generic input, output, or processing on a computer. The query result (corresponding to actual finances of a user, e.g., actual funds) according to the systems, methods, and devices described herein represents non-standard output. The frozen funds according to the systems, methods, and devices described herein represent non-standard output. Such functionality produces a discernible physical effect or change.

Advantageously, the user may make online payments for online shopping via the financial services aggregation system without re-inputting personal payment information in order to improve the efficiency and security of the computer performing online personal financial activities.

Some or all of the functionality of the systems, methods, and devices disclosed and described herein may be provided through an analog device or peripheral. Such an analog device may include a means of communicating with or transmitting instructions to or from a server, a bank, the systems, methods, and devices disclosed and described herein, and/or other analog devices or peripherals. Such peripherals may include a keyboard, a mouse, a laser pointer, or other mechanical or analog peripherals for a user to communicate with or transmit instructions to or from any or all of the foregoing categories.

It will be understood that each of the embodiments disclosed and described herein, in an aspect, includes the functionality of communicating physically and/or in an analog fashion, between a user and devices. Such physical communication forms a part of the aspects of the embodiments. Such physical communication may be accomplished by, for example, a user interacting with a peripheral (e.g., physically depressing keys on a keyboard, physically clicking on a mouse, physically moving and/or depressing a laser pointer) and/or a device providing feedback to a user (e.g. a device causing vibration or other haptics to provide information to a user).

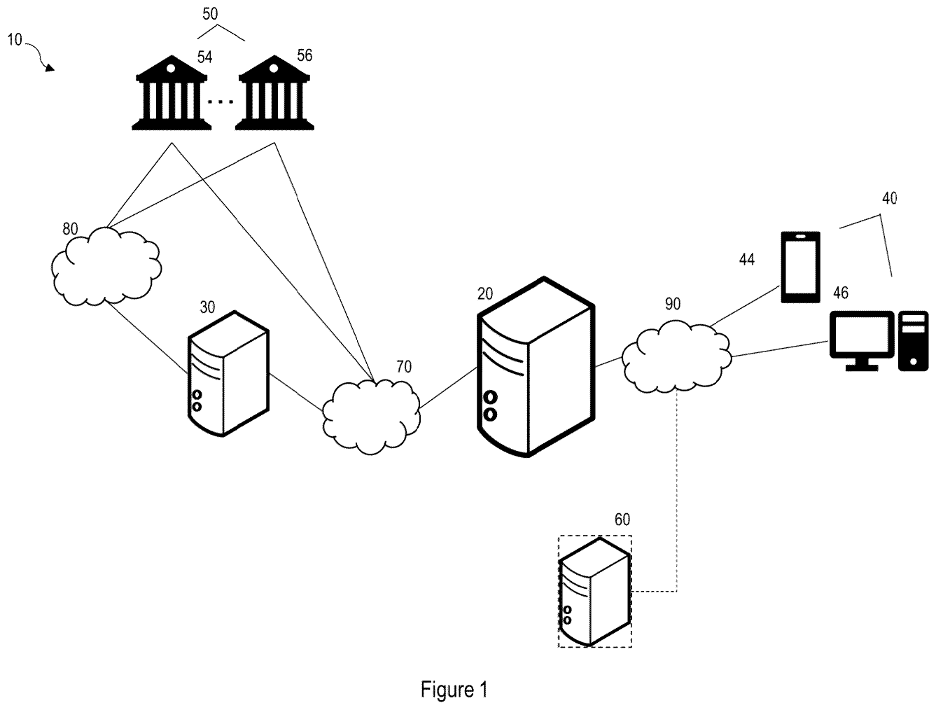

Referring now to FIG. 1, shown therein is a schematic diagram illustrating an exemplary embodiment of a financial services aggregation system 10.

The financial services aggregation system 10 includes a financial vault 20 for supporting financial services between a client terminal 40, an e-commerce platform 60, and a plurality of FI systems 50 (collectively referred to as the FI systems 50 and generically referred to as the FI system 50) through communication via a network 70. The financial services aggregation system 10 further includes a user aggregation identity system 30, which is communicatively connected to the plurality of FI systems 50 for user financial identity verification and authentication via a network 80.

The financial vault 20 serves as a gateway to communicatively link a FI system side and a client terminal side.

The user aggregation identity system 30 is further configured to provide permission for accessing a user's financial account on the FI systems 50 to the client terminal 40 through the financial vault 20.

The client terminal 40 includes an application programming interface (API) (not shown) for communicatively interacting with other components of the financial services aggregation system 10 via a network 90.

In some examples, the networks 70, 80, 90 may all be the same network. For example, this single unified network may be the Internet, or an internal private network. In other examples, the networks 70, 80, 90 may be different networks, or some networks 70, 80, 90 may be the same network, while others may differ (e.g. networks 80, 90 may be the same network, while network 70 may be a different network.

The financial vault 20, the user aggregation identity system 30, and the client terminal 40 may be any of a server computer, desktop computer, notebook computer, tablet, PDA, smartphone, or another computing device. The financial vault 20, the user aggregation identity system 30, and the FI systems 50 may each include a connection to the network 70 such as a wired or wireless connection to the Internet. The user aggregation identity system 30, the FI systems 50, and the e-commerce platform 60 may each include a connection with the network 80 such as a wired or wireless connection to the Internet. The financial vault 20, the client terminal 40, and the e-commerce platform 60 may each include a connection with the network 90 such as a wired or wireless connection to the Internet. In some cases, the networks 70, 80, and 90 may include other types of computer or telecommunication networks. The financial vault 20, the user aggregation identity system 30, the client terminal 40, the FI systems 50 and the e-commerce platform 60 may include one or more of a memory, a secondary storage device, a processor, an input device, a display device, and an output device. Memory may include secure random access memory (RAM) or similar types of memory. Also, memory may store one or more applications for execution by a processor. Applications may correspond with software modules comprising computer executable instructions to perform processing for the functions described below. Secondary storage devices may include a hard disk drive, floppy disk drive, CD drive, DVD drive, Blu-ray drive, or other types of non-volatile data storage.

The processor may execute applications, computer readable instructions, or programs. The applications, computer readable instructions, or programs may be stored in memory or in secondary storage or may be received from the Internet or from another network. The applications, computer readable instructions, or programs may be operated in a computer operating system. The input device may include any device for entering information into the financial vault 20, the user aggregation identity system 30, and the client terminal 40. For example, the input device may be a keyboard, keypad, cursor-control device, touch-screen, camera, or microphone. The display device may include any type of device for presenting visual information. For example, the display device may be a computer monitor, a flat-screen display, a projector or a display panel. In some cases, the financial vault 20, the user aggregation identity system 30, and the client terminal 40 may include multiple of any one or more of processors, applications, software modules, secondary storage devices, network connections, input devices, and display devices.

Although the financial vault 20, the user aggregation identity system 30, the client terminal 40, and the e-commerce platform 60 are described with various components, one skilled in the art will appreciate that the financial vault 20, the user aggregation identity system 30, the client terminal 40, and the e-commerce platform 60 may in some cases include fewer, additional, or different components. In addition, although aspects of an implementation of the financial vault 20, the user aggregation identity system 30, and the client terminal 40 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the financial vault 20, the user aggregation identity system 30, the client terminal 40, and/or the processor to perform a particular method.

In the description that follows, devices such as the financial vault 20, the user aggregation identity system 30, and the client terminal 40 are described performing certain acts. It will be appreciated that any one or more of these devices may perform an act automatically or in response to an interaction by a user of that device. That is, the user of the device may manipulate one or more input devices (e.g., a touchscreen, a mouse, a button) causing the device to perform the described act. In many cases, this aspect may not be described below, but it will be understood.

As an example, it is described below that the client terminal 40 may deliver information to the financial vault 20. For example, a user using the client terminal may manipulate one or more input devices (e.g., a mouse and a keyboard and a touchscreen) to interact with a user interface displayed on a display of the client terminal 40. Generally, a user interface may be stored locally at the client terminal 40 (e.g., a cache of a webpage or a mobile application). Alternatively, or in addition, the client terminal 40 may receive a user interface over the network 90 (e.g., in the form of a webpage) from another device(s) connected to network 90 (not pictured).

The financial vault 20 may be configured to receive a plurality of information from the client terminal 40 and the user aggregation identity system 30. Generally, the information may comprise at least processing data.

In response to receiving information, the financial vault 20 may store the information in a storage database (not shown). The storage database may correspond with secondary storage of the user aggregation identity system 30 and the client terminal 40. Generally, the storage database may be any suitable storage device such as a hard disk drive, a solid state drive, a memory card, or a disk (e.g., CD, DVD, Blu-ray). Moreover, the storage database may be locally connected with the financial vault 20. In some cases, the storage database may be located remotely from the financial vault 20 and may be securely accessible to the financial vault 20 across a network. In some cases, the storage database may comprise one or more storage devices located at a networked cloud storage provider.

The financial vault 20 is further communicatively connected to the user aggregation identity system 30 via the network 70. The financial vault 20 is configured to deliver a request for accessing a user's financial account to the user aggregation identity system 30 for identity verification and authentication when the user is logging into the user's account on the client terminal 40. In some examples, such a request may be generated or otherwise initiated by client terminal 40, or software internal to financial vault 20.

The financial vault 20 is configured to retrieve specific information about available financial services provided by a specific FI system 50 if such information is requested or required by the client terminal 40.

For example, the financial vault 20 communicates with the plurality of FI systems 50 to obtain all information of available financial services provided by the plurality of FI systems 50 for users via the network 70. These available financial services may be displayed on the client terminal 40 to enable users to check the detailed information of available financial services and compare features of available financial services with users' current financial services. The user may utilize such information to decide whether to switch their financial services to another provider or financial institution or remain with their current provider.

The available financial services may involve any one or more of credit cards, insurance, loans, and the like. For example, a user may already have a credit card associated with Bank A but does not have a credit card associated with Bank B. Accordingly, the user may interact with the client terminal 40 to obtain information about all types of credit cards available from Bank B through the financial vault 20 and to compare features (annual fee, interest rate, cash back, rewards, and the like) among the credit card of Bank A and a plurality of credit cards of Bank B. If the user decides to choose the credit card of Bank B, the user may interact with the client terminal 40 to apply for the credit card of Bank B through a banking system (such as a FI system 50) of Bank B through the financial vault 20.

The financial vault 20 is further configured to receive a confirmation message from the user aggregation identity system 30 when a user's identity has been verified and the user's financial account has been authenticated by the user aggregation identity system 30.

The financial vault 20 is further configured to deliver a query request to FI systems 50.

In some examples, the client terminal 40 may initiate the query request on the financial vault 20.

In some examples, the client terminal 40 may initiate the query request to access personal banking data under the user's financial account on the FI systems 50.

The financial vault 20 is further configured to retrieve personal banking data from at least one financial account of a user on the FI systems 50 when the query request is responded by the FI systems 50.

The financial vault 20 is further configured to aggregate personal banking data from the user's financial accounts on the plurality of financial systems 50. In an embodiment, the financial vault 20 is configured to aggregate personal banking when a query request is responded to by the FI systems 50.

The financial vault 20 is further configured to allow the client terminal 40 to access basic banking services such as checking current account balance and transaction history, making transactions, paying bills, and the like.

The user's financial accounts are all financial accounts under the user's name and corresponding identity information. These financial accounts are registered on the plurality of FI systems 50.

The user's financial accounts include at least one of checking, savings, investments, loans, and rewards accounts, as well as any other functional accounts.

The financial vault 20 is further configured to deliver a query result of the personal banking data from the FI systems 50 to the client terminal 40. The query result of the personal banking data includes the personal banking data about one or more of the basic banking services such as checking current account balance and transaction history, making transactions, paying bills, and the like. For example, the user may interact with the client terminal 40 to access all of the user's financial accounts through the financial vault 20 to check a payment amount and due date on an FI system 50 of Bank B and make a payment from a different FI system 50 of Bank C to the FI system 50 of Bank B. The financial services aggregation system 10 enables the user to manage interbank financial services conveniently and effectively. Advantageously, the user may not need to switch accounts to which the user is logged in among various financial institution applications to interact with accounts from different financial institutions simultaneously or sequentially.

The financial vault 20 is further configured to analyze processing data on the client terminal 40 through the financial vault 20 by using machine-learning algorithms to provide summary financial data.

The processing data of the client terminal 40 includes data on any past event related to financial services on the client terminal 40. The data may be accessed through communication with the financial vault 20, for example, the user's transaction history (including debit and credit transaction data). Summary financial data is extracted from the processing data of the client terminal 40. Accordingly, the user's financial profiles may be analyzed based on the summary financial data, such as the user's spending habit, income and risk tolerance, investment preference, and the like.

The financial vault 20 is further configured to predict future transactions by using machine leaning algorithms to provide recommended financial services to the user via the client terminal 40. For example, new financial service recommendations, reminders for upcoming payments, alerts for possible benefits/repercussions of certain purchases, and the like.

The user aggregation identity system 30 is configured to verify the user's identity and authenticate the user's financial account according to the request for access to the user's financial account delivered by the financial vault 20.

The user aggregation identity system 30 is further configured to deliver the confirmation message of verification and authentication to the financial vault 20 when the user's identity has been verified and the user's financial account has been authenticated by the user aggregation identity system 30.

The user aggregation identity system 30 is further configured to provide permission for accessing the user's financial account on the financial institution system 50 to the user via the client terminal 40 through the financial vault 20.

The user aggregation identity system 30 may be a third-party verification and authentication provider, which securely communicates with the financial vault 20 by using a set of credentials (not shown). The set of credentials may include a client ID, a public key, an access token, a public key, and two private keys.

The client ID includes two private API (Application Programming Interface) keys to be used in conjunction with an access token to access data from an item.

The public key is a public API identifier and is used to initialize a link and identify the item created or updated via the link.

The access token is a rotatable token unique to a single item and is used to access data for that item.

The public token is a short-lived token that can be exchanged for an access token or used to initialize a link in an update mode for an item.

The user aggregation identity system 30 may be a third-party account aggregation provider, which securely communicates with the financial vault 20 by using the user's online banking website access (e.g., username and password).

The client terminal 40 includes an application programming interface (API) for communicatively interacting with the financial services aggregation system 10 via the network 90.

The client terminal 40 is configured to deliver the request for accessing the user's financial account to the financial vault 20 when the user logs into the user's account.

The client terminal 40 is further configured to initiate the query request at the financial vault 20 and to access personal banking data under the user's financial account on the FI systems 50 once verification and authentication of the user's financial account have been successfully completed.

The personal banking data is retrieved by the financial vault 20 from the user's at least one financial account on one of the plurality of FI systems 50, when the query request is responded to by the FI systems 50.

The personal banking data from all the user's financial accounts on the plurality of FI systems 50 is aggregated on the financial vault 20 when the query request is responded to by the FI systems 50.

The client terminal 40 is further configured to interact with the financial vault 20 to access basic banking services such as checking current account balance and transaction history, making transactions, paying bills, and the like.

The user's financial accounts may all be financial accounts under the user's name and corresponding identity information. These financial accounts are registered on a plurality of FI systems 50.

The user's financial account includes at least one of chequing, savings, investments, loans, rewards accounts, and any other functional accounts.

The user's financial accounts may be accessed by the financial vault 20 via a third-party verification and authentication provider for interacting with the client terminal 40.

The user's financial accounts may be accessed by the financial vault 20 via a third-party account aggregation provider interacting with the client terminal 40.

The client terminal 40 is further configured to deliver a request to retrieve specific information about available financial services to the financial services aggregation system 10. The specific information about available financial services is provided by any other financial institutions and displayed on the client terminal 40 to enable users to check the detailed information of available financial services and compare features of available financial services with users' current financial services to decide to switch or stay.

The client terminal is further configured to receive a query result of the personal banking data from the FI systems 50 by the financial vault 20.

The query result of the personal banking data includes personal banking data about one or more basic banking services such as checking current account balance and transaction history, making transactions, paying bills, and the like. For example, the user may interact with the client terminal 40 to access all the user's financial accounts through the financial vault 20 to check a payment amount and due date on Bank B's FI system 50 and make a payment from Bank C's FI system 50 to Bank B's FI system 50. The financial services aggregation system 10 enables the user to process interbank financial services conveniently and effectively. Advantageously, the user may not need to switch accounts to which the user is logged in among various financial institution applications.

The client terminal 40 is further configured to check summary financial data provided by the financial vault 20.

The summary financial data is generated by machine-learning algorithms based on analyzing processing data on the client terminal 40.

The processing data of the client terminal 40 includes data on any past event related to financial services on the client terminal 40 through the financial vault 20, for example, the user's transaction history (including debit and credit transaction data). The summary financial data is extracted from the processing data of the client terminal 40. Accordingly, the user's financial profiles may be analyzed based on the summary financial data, such as user's spending habit, income and risk tolerance, investment preference, and the like.

The client terminal 40 is further configured to check recommended financial services provided by the financial vault 20.

The recommended financial services are generated by machine-learning algorithms based on predicting future transactions. For example, new financial service recommendations, reminders for f upcoming payments, alerts for possible benefits/repercussions of certain purchases, and the like.

The FI systems 50 include systems of issuing banks, financial institutions, and third-party financial service providers.

The systems of issuing banks provide personal banking data, such as an account balance, account profile, transaction history, and the like.

The systems of financial institutions and third-party financial service providers provide financial services data, such as credit card information, mortgages, loans, and the like.

The personal banking data and financial services data are delivered to the financial vault 20 via the user aggregation identity system 30 once the identity verification and authentication have been successfully completed by the user aggregation identity system 30.

The E-commerce platform 60 supports a payment transaction in an online order when the client terminal 40 places the online order on the e-commerce platform 60. The e-commerce platform 60 is communicatively connected to the client terminal 40, the financial vault 20, and the FI systems 50.

The client terminal 40 includes a buyer's terminal 44 and a seller's terminal 46.

The FI systems 50 include an FI system 54 of a buyer, for example, a banking system includes a bank account of a buyer.

The FI systems 50 includes a FI system 56 of a seller, for example, a banking system includes a bank account of a seller.

The e-commerce platform 60 is configured to generate and deliver a payment request from the seller's terminal 46, according to an order placed by the buyer's terminal 44, to the buyer's financial account synced on the financial vault 20 for requesting a payment for the seller's terminal 46.

The payment request includes order information and an identification code of the seller's financial account.

The order information includes at least a payment amount and order number.

The financial vault 20 is configured to deliver a payment message from the seller's terminal 46, according to the order placed by the buyer's terminal 44, to the FI system 56 of the seller for reference, when receiving the payment message of the seller's terminal 46 delivered by the e-commerce system 60.

The payment message includes the order information and an identification code of the buyer's financial account.

The FI system of the buyer 54 is further configured to freeze the amount of funds in a designated buyer's financial account equivalent to the amount of funds of the payment order, when receiving a request for funds of the order delivered by the buyer's terminal 44 through the financial vault 20.

The FI system of the buyer 54 is further configured to deliver a frozen-funds confirmation message to the e-commerce platform 60 through the financial vault 20. The frozen-funds confirmation message enables the status of the frozen amount of funds to be unavailable for any other purpose in the buyer's financial account.

The e-commerce platform 60 is further configured to forward the frozen-funds confirmation message to the seller's terminal 46, to enable the seller's terminal 46 to arrange the order delivery, when receiving the frozen-funds confirmation message delivered by the FI system 54 of the buyer through the financial vault 20.

The financial vault 20 is further configured to deliver a transfer request to the FI system 54 of the buyer when receiving a delivery receipt sent by the buyer's terminal 44, to enable the frozen amount of funds to be unfrozen and transferred from the buyer's financial account to the seller's financial account, according to the payment request of the seller's terminal 46. In an alternate embodiment, different, non-frozen funds for transfer may be transferred, with the frozen funds remaining in the buyer's financial account to be unfrozen after the funds for transfer have been transferred.

The buyer's terminal 44 is further configured to deliver the delivery receipt to the e-commerce platform 60 as well, to enable the e-commerce platform 60 to update the order status.

The financial vault 20 is further configured to receive a funds receipt delivered by the FI system 56 of the seller.

The funds receipt is generated by the FI system 56 of the seller, when the FI system 56 of the seller has received the amount of funds for the order.

The financial vault 20 is further configured to deliver the funds receipt to the e-commerce platform 60, to enable the e-commerce platform 60 to update the order status.

The financial vault 20 is further configured to store all processing data related to the user's operational commands and logs. The processing data of the client terminal includes any past event related to financial services by the client terminal 40 on the financial services aggregation system 10.

Advantageously, the financial vault 20 may reduce a great number of requests made by a plurality of financial applications to various lines of backend services.

Advantageously, the user may make online payments for online shopping via the financial services aggregation system 10 without re-inputting personal payment information in order to improve the efficiency and security of online personal financial activities.

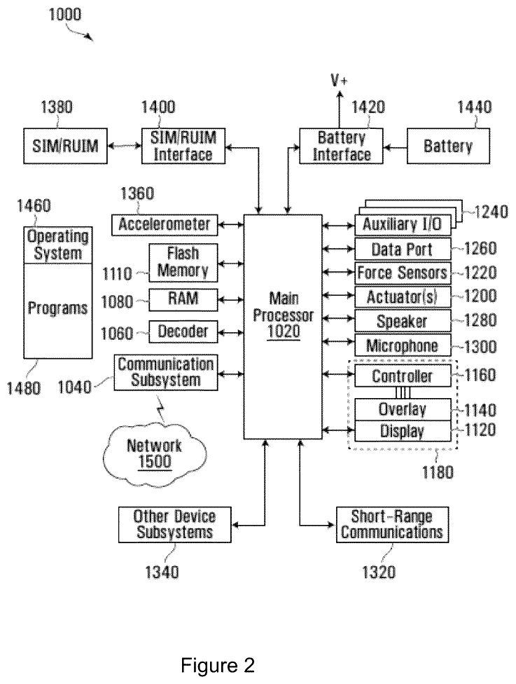

Referring now to FIG. 2, shown there is a block diagram of a computing device 1000 for the financial services aggregation system 10 of FIG. 1, according to an embodiment. The computing device 1000 may be, for example, any one of devices 20, 30, 40, 50, and 60 of FIG. 1.

The computing device 1000 includes multiple components such as a processor 1020 that controls the operations of the computing device 1000. Communication functions, including data communications, voice communications, or both may be performed through a communication subsystem 1040. Data received by the computing device 1000 may be decompressed and decrypted by a decoder 1060. The communication subsystem 1040 may receive messages from and deliver messages to a wireless network 1500.

The wireless network 1500 may be any type of wireless network, including, but not limited to, data-centric wireless networks, voice-centric wireless networks, and dual-mode networks that support both voice and data communications.

The computing device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1110, a display 1120 (e.g., with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a computing device generated by the processor 1020 may be displayed on the touch-sensitive display 1180.

The processor 1020 may also interact with an accelerometer 1360. The accelerometer 1360 may be utilized for detecting direction of gravitational forces or gravity-induced reaction forces.

To identify a subscriber for network access according to the present embodiment, the computing device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1110 or performed using other techniques.

The computing device 1000 also includes an operating system 1460 and software components 1480 that are executed by the processor 1020 and which may be stored in a persistent data storage device such as the flash memory 1110. Additional applications may be loaded onto the computing device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the computing device 1000 may be similar. The speaker 1280 may output audible information converted from electrical signals, and the microphone 1300 may convert audible information into electrical signals for processing.

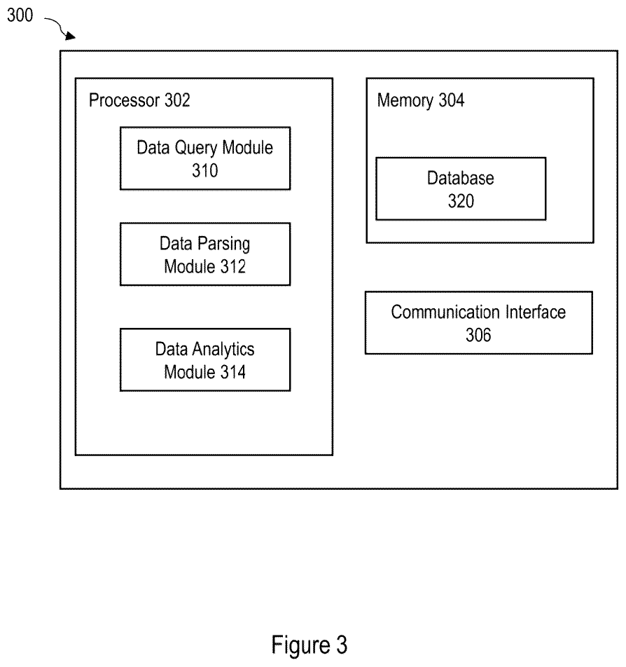

Turning now to FIG. 3, shown therein is a block diagram of a computer system 300 for aggregating financial services, according to an embodiment.

The computer system 300 includes a processor 302, a memory 304, and a communication interface 306 for interacting with the end user.

The processor 302 includes a data query module 310 for financial data queries, a data parsing module 312 for parsing financial data and processing data, and a data analytics module 314 for analyzing processing data and financial data predictions through application of machine-learning algorithms.

The memory 304 includes a database 320 for storing the processing data.

The data query module 310 is configured to deliver a request for accessing a user's financial account to the user aggregation identity system 30 for identity verification and authentication when the user is logging into the user's account on the client terminal 40.

The data parsing module 312 is configured to receive a confirmation message from the user aggregation identity system 30 when the user's identity has been verified and the user's financial account has been authenticated by the user aggregation identity system 30.

The data query module 310 is further configured to retrieve specific information about available financial services provided by a specific FI system if requested by the client terminal 40.

The data query module 310 is further configured to deliver a query request to the FI systems 50, when the client terminal 40 has initiated the query request on the financial vault 20, to access personal banking data under the user's financial account on the FI systems 50.

The data query module 310 is further configured to retrieve personal banking data through the financial vault 20 from at least one financial account of the user on the one of FI systems 50, when the query request is responded to by the FI systems 50.

The data parsing module 312 is configured to aggregate personal banking data from all the user's financial accounts on the plurality of FI systems 50 when the query request is responded to by the FI systems 50.

The data query module 310 is further configured to allow the client terminal 40 to access basic banking services such as checking current account balance and transaction history, making transactions, paying bills, and the like.

The user's financial accounts are all financial accounts under the user's name and corresponding identity information. The user's financial accounts are registered on the plurality of FI systems 50.

Each of the user's financial accounts includes at least one checking, savings, investments, loans, and/or rewards accounts, as well as any other functional accounts.

The data query module 310 is further configured to deliver a query result of the personal banking data from the FI systems 50 to the client terminal 40.

The data analytics module 314 is configured to analyze processing data on the client terminal 40 through the financial vault 20 by using machine-learning algorithms to provide summary financial data.

The processing data of the client terminal 40 includes data on any past event related to financial services on the client terminal 40 through the financial vault 20, for example, the user's transaction history (including debit and credit transaction data). The summary financial data is extracted from the processing data of the client terminal. Accordingly, the user's financial profiles may be analyzed based on the summary financial data, such as the user's spending habits, income and risk tolerance, investment preference, and the like.

The data analytics module 314 is configured to predict future transactions by using machine-learning algorithms to provide recommended financial services to the client terminal 40. For example, new financial service recommendations, reminders for upcoming payments, alerts for possible benefits/repercussions of certain purchases, and the like.

The database 320 is configured to store all processing data related to the user's operational commands and logs. The processing data of the client terminal 40 includes any past event related to financial services on the financial services aggregation system 10.

Advantageously, the financial services aggregating system 10 includes a financial vault 20 for reducing a great number of requests made by a plurality of financial applications to various lines of backend services.

In addition, the user may make online payments for online shopping via the financial services aggregation system 10 without re-inputting personal payment information in order to improve the efficiency and security of online personal financial activities.

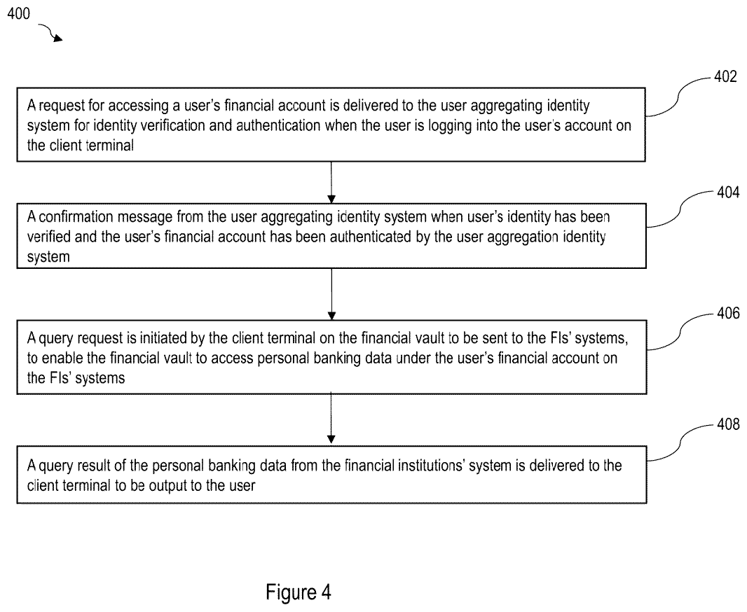

Turning now to FIG. 4, shown therein is a flow chart of a computer implemented method 400 for aggregating financial services, according to an embodiment.

At 402, a request for accessing a user's financial account is delivered to the user aggregation identity system for identity verification and authentication when the user is logging into the user's account on the client terminal.

At 404, a confirmation message is received from the user aggregation identity system when the user's identity has been verified and the user's financial account has been authenticated by the user aggregation identity system.

At 406, a query request is initiated by the client terminal on the financial vault to be sent to the FI systems, to enable the financial vault to access personal banking data under the user's financial account on the FI systems.

At 408, a query result of the personal banking data from the financial institution system is delivered to the client terminal to be output to the user.

Advantageously, the financial services aggregating system including a financial vault may reduce a great number of requests made by a plurality of financial applications to various lines of backend services.

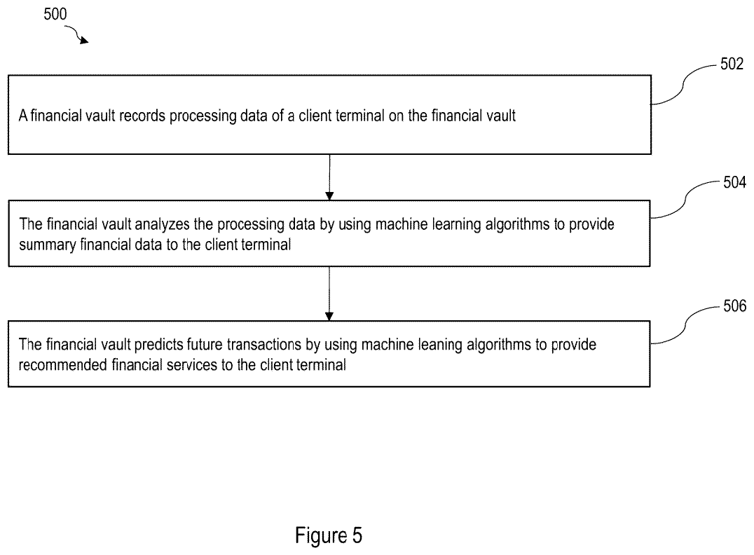

Turning now to FIG. 5, shown therein is a flow chart of a computer implemented method 500 of aggregating financial services in a financial vault, according to an embodiment.

At 502, a financial vault records processing data of a client terminal on the financial vault.

At 504, the financial vault analyzes the processing data by using machine-learning algorithms to provide summary financial data to the client terminal.

The processing data of the client terminal includes data on any past event related to financial services on the client terminal through the financial vault, for example, the user's transaction history (including debit and credit transaction data). The summary financial data is extracted from the processing data of the client terminal. Accordingly, the user's financial profiles may be analyzed based on the summary financial data, such as user's spending habits, income and risk tolerance, investment preference, and the like.

The summary financial data is generated by machine-learning algorithms based on analyzing the processing data on the client terminal.

At 506, the financial vault predicts future transactions by using machine-learning algorithms to provide recommended financial services to the client terminal 40.

For example, new financial service recommendations, reminders for upcoming payments, alerts for possible benefits/repercussions of certain purchases, and the like.

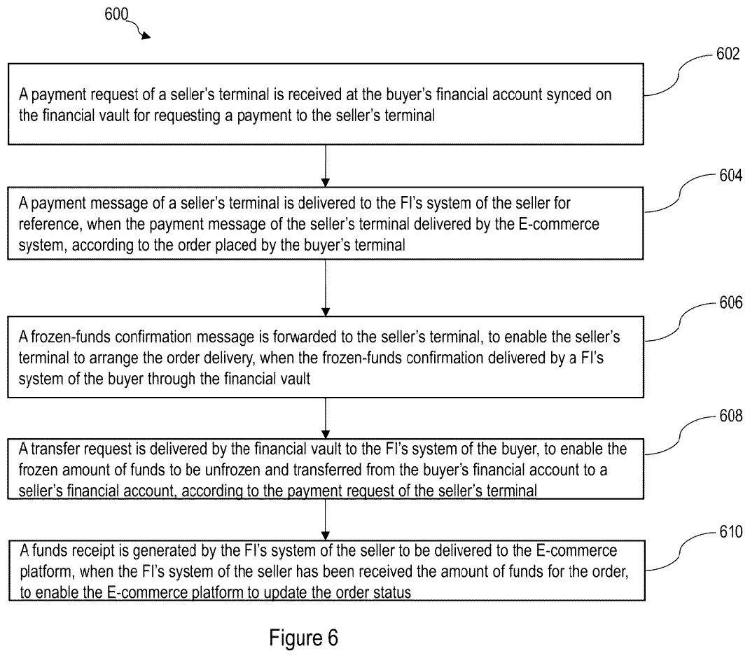

Turning now to FIG. 6, shown therein is a flow chart of a computer implemented method 600 for aggregating financial services in an ecommerce transaction, according to an embodiment.

At 602, a payment request of a seller's terminal is received at the buyer's financial account synced on the financial vault for requesting a payment to the seller's terminal.

At 604, the payment message of a seller's terminal is delivered to the FI system of the seller for reference, when the payment message of the seller's terminal delivered by the e-commerce system, according to the order placed by the buyer's terminal.

At 606, a frozen-funds confirmation message is forwarded to the seller's terminal, to enable the seller's terminal to arrange the order delivery, when the frozen-funds confirmation is delivered by a FI system of the buyer through the financial vault.

At 608, a transfer request is delivered by the financial vault to the FI system of the buyer, to enable the frozen amount of funds to be unfrozen and transferred from the buyer's financial account to a seller's financial account, according to the payment request of the seller's terminal.

At 610, a funds receipt is generated by the FI system of the seller to be delivered to the e-commerce platform, when the FI system of the seller has received the amount of funds for the order, to enable the e-commerce platform to update the order status.

Advantageously, the financial services aggregating system including a financial vault may reduce a great number of requests made by a plurality of financial applications to various lines of backend services.

In addition, the user may be able to make online payments for online shopping via the financial services aggregation system without re-inputting personal payment information in order to improve the efficiency and security of online personal financial activities.

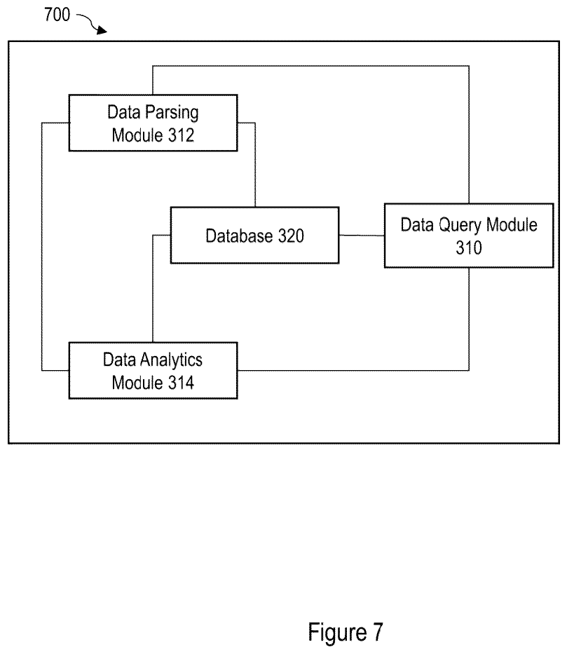

Referring now to FIG. 7, shown there is a block diagram of a computer server 700 for aggregating financial services, according to an embodiment. The computer server 700 may be implemented at one or more devices of the financial services aggregation system 10 of FIG. 1. Identical numerals may denote identical references with respect to FIG. 3.

The computer server 700 includes a data query module 310, a data parsing module 312, a data analytics module 314 and a database 320. The data query module 310, the data parsing module 312, the data analytics module 314, and the database 320 may perform identical or similar functionality in the computer server 700 as in the computer system 300.

Advantageously, the financial services aggregating system 10 including a financial vault 20 may reduce a great number of requests made by a plurality of financial applications to various lines of backend services.

In addition, the user may be able to make online payments for online shopping via the financial services aggregation system 10 without re-inputting personal payment information in order to improve the efficiency and security of online personal financial activities.

While the above description provides examples of one or more apparatus, devices, methods, or systems, it will be appreciated that other apparatus, devices, methods, or systems may be within the scope of the claims as interpreted by one of skill in the art.

1. A financial services aggregation system comprising:
a financial vault for supporting financial services between a client terminal and a plurality of financial institution systems, configured to:
receive a query request for accessing a plurality of financial accounts of a user and deliver the request to a user aggregation identity system for identity verification and authentication when the user logs into a user account on the client terminal to access the plurality of financial accounts on the client terminal, each financial account associated with a respective financial institution system;
receive a confirmation message from the user aggregation identity system when the identity of the user has been verified and the plurality of financial accounts have been authenticated by the user aggregation identity system; and
deliver a query result from at least one of the plurality of financial institution systems to the client terminal;
the client terminal for accessing the plurality of financial accounts and configured to:
deliver the query request for accessing the plurality of financial accounts to the financial vault when the user logs into the user account;
initiate the query request on the financial vault, to access personal banking data under the plurality of financial accounts on the respective financial institution systems, when the identity of the user has been verified and the plurality of financial accounts have been authenticated;
receive the query result including at least some of the personal banking data from the at least one of the respective financial institution systems through the financial vault;
the user aggregation identity system configured to:
verify the identity of the user and authenticate the plurality of financial accounts according to the request;
deliver the confirmation message for identity verification and authentication for the plurality of financial accounts to the financial vault when the identity of the user has been verified and the plurality of financial accounts have been authenticated; and
provide a permission for accessing the plurality of financial accounts on the respective financial institution systems to the client terminal through the financial vault.

2. The system of claim 1, wherein the financial vault is further configured to analyze processing data on the client terminal by using machine-learning algorithms to provide summary financial data.

3. The system of claim 2, wherein the processing data includes data on any past event related to financial services on the client terminal.

4. The system of claim 1, wherein the financial vault is further configured to predict future transactions by using machine-learning algorithms to provide recommended financial services to the client terminal.

5. The system of claim 4, wherein the recommended financial services are generated by the machine-learning algorithms based on predicting the future transactions.

6. The system of claim 1 further including an e-commerce platform.

7. The system of claim 6, wherein the e-commerce platform is communicatively connected to the client terminal and the respective financial institution systems.

8. The system of claim 2, wherein the e-commerce platform is configured to:
generate and deliver a payment request of a seller terminal, according to an order placed by the client terminal, to one of the plurality of financial accounts synced on the financial vault for requesting a payment to the seller terminal;
forward a frozen-funds confirmation message to the seller terminal, to enable the seller terminal to arrange delivery of an order when receiving the frozen-funds confirmation message delivered by the respective financial institution system corresponding to the one of the plurality of financial accounts through the financial vault;
receive a delivery receipt received by the client terminal, to enable a frozen amount of funds to be unfrozen and transferred from the one of the plurality of financial accounts to a seller financial account; and
deliver a funds receipt received by the financial fault, to update order status.

9. The system of claim 2, wherein the financial vault is further configured to:
receive the payment request of the seller terminal delivered by the e-commerce platform, according to an order placed by the client terminal;
deliver the request for accessing the plurality of financial accounts to the user aggregation identity system when the user logs into one of the plurality of financial accounts on the client terminal;
forward a request for funds of the order received by the client terminal to one of the respective financial institution systems, to enable the one of the respective financial institution systems to freeze the amount of funds in one of the plurality of financial accounts equivalent to an amount of funds of a payment order;
deliver a transfer request to the one of the respective financial institution systems when receiving the delivery receipt sent by the client terminal, to enable the frozen amount of funds to be unfrozen and transferred from the one of the plurality of financial accounts to a financial account of a seller, according to the payment request of a terminal of the seller; and
forward a funds receipt delivered by a financial institution system of a seller to the e-commerce platform, to enable the e-commerce platform to update the order status.

10. The system of claim 1, wherein the user aggregation identity system is communicatively connected to the respective financial institution systems for identity verification and authentication via a network.

11. The system of claim 1, wherein the respective financial accounts are financial accounts under the name of the user and associated with corresponding identity information.

12. The system of claim 1, wherein the plurality of financial accounts are registered on the respective financial institution systems.

13. The system of claim 1, wherein the plurality of financial accounts include at least one functional account.

14. The system of claim 13, wherein the functional account includes a checking account.

15. The system of claim 13, wherein the functional account includes a savings account.

16. The system of claim 13, wherein the functional account includes an investment account.

17. The system of claim 13, wherein the functional account includes a loan account.

18. A computer implemented method for a financial services aggregation system comprising:
delivering a request for accessing a plurality of financial accounts of a user to a user aggregation identity system for identity verification and authentication when logging into a user account on a client terminal, each financial account associated with a respective financial institution system;
receiving a confirmation message from the user aggregation identity system when the identity of the user has been verified and the plurality of financial accounts have been authenticated by the user aggregation identity system;
initiating a query request at the client terminal on a financial vault to send the query request to the respective financial institution systems, to enable the financial vault to access personal banking data under the plurality of financial accounts on the financial institution systems; and
delivering a query result including the personal banking data from at least one of the respective financial institution systems to the client terminal.

19. The method of claim 18, further including:
receiving a payment request delivered by an e-commerce platform, according to an order placed by the client terminal;
delivering a payment message of a seller terminal, according to the order placed by the client terminal, to a financial institution system of a seller for reference; and
delivering a transfer request to the respective financial institution system when receiving a delivery receipt sent by the client terminal, to enable a frozen amount of funds to be unfrozen and transferred from one of the plurality of financial accounts to a financial account of a seller, according to the payment message.

20. A computer server in a financial services aggregation system comprising:
a data query module, configured to:
deliver a query request for accessing one of a plurality of financial accounts to a user aggregation identity system for identity verification and authentication when a user logs into a user account on a client terminal, each financial account associated with a respective financial institution system;
retrieve specific information about available financial services provided by a specific financial institution system as requested by the client terminal; and
deliver a query result including personal banking data from at least one of the respective financial institution systems to the client terminal;
a data parsing module, configured to:
receive a confirmation message from the user aggregation identity system when the identity of the user has been verified and the plurality of financial accounts have been authenticated by the user aggregation identity system; and
aggregate the personal banking data from the plurality of financial accounts on the respective financial institution systems when the query request is responded to by the respective financial institution systems;
a data analytics module configured to:
analyze processing data related to operational commands and logs on the client terminal through the financial vault by using machine-learning algorithms to provide summary financial data; and
predict future transactions by using the machine-learning algorithms to provide recommended financial services to the client terminal; and
a database for storing the processing data.

21-42. (canceled)
